(19) United States
(12) Patent Application Publication
(10) Pub. No.: US 2025/0136778 A1
(43) Pub. Date: May 1, 2025

(54) METHOD FOR PRODUCING RESIN COMPOSITION

(71) Applicant: YKK AP Inc., Tokyo (JP)

(72) Inventor: Yuya Oyama, Tokyo (JP)

(21) Appl. No.: 18/885,798

(22) Filed: Sep. 16, 2024

(30) Foreign Application Priority Data
Oct. 25, 2023 (JP) 2023-183410

(51) Int. Cl. C08J 11/08

(52) U.S. Cl. CPC C08J 11/08; C08J 2327/06

(57) ABSTRACT

Provided is a method for producing a resin composition of polyvinyl chloride by removing lead in a resin molded article containing polyvinyl chloride as a main component and a lead-based stabilizer. The method includes: pulverizing the resin molded article to form a pulverized material; immersing the pulverized material in an acidic or alkaline liquid to dissolve lead contained in the lead-based stabilizer from the pulverized material into the liquid; and separating the pulverized material from the liquid in which the lead is dissolved.

### CROSS-REFERENCE TO RELATED APPLICATION(S)

The present application claims priority to and incorporates by reference the entire contents of Japanese Patent Application No. 2023-183410 filed in Japan on Oct. 25, 2023.

### BACKGROUND

### 1. Technical Field

The present disclosure relates to a method for producing a resin composition for producing a resin composition of polyvinyl chloride from a resin molded article of polyvinyl chloride containing a lead-based stabilizer.

### 2. Related Art

In window units such as resin windows, resin molded articles such as resin profiles containing polyvinyl chloride as a main component are used. In addition, conventionally, resin molded articles containing a lead-based stabilizer as a heat stabilizer have been used. When a resin composition of polyvinyl chloride is produced by recycling such a resin molded article containing a lead-based stabilizer, it is preferable to remove lead in the resin molded article from the viewpoint of safety and the like. Meanwhile, conventionally, a method for collecting polyvinyl chloride is known in which heavy metals are removed from a waste vinyl chloride resin composition to collect polyvinyl chloride (see JP 2008-174666 A).

In the conventional method for collecting polyvinyl chloride described in JP 2008-174666 A, a waste vinyl chloride resin composition is dissolved in an organic solvent to prepare a polymer solution. In addition, after the polymer solution is brought into contact with an adsorbent, heavy metals are removed from the polymer solution by solid-liquid separation. However, the treatment of dissolving the waste vinyl chloride resin composition in the organic solvent and the treatment of preparing the polymer solution may take time and effort. In addition, when polyvinyl chloride is collected from the polymer solution from which heavy metals have been removed, it is necessary to bring the polymer solution into contact with a solution for precipitation to precipitate polyvinyl chloride, and there is possibility that the process for collecting and recycling polyvinyl chloride becomes complicated.

### SUMMARY

The disclosure has been made in view of the above conventional problems, and it is desirable to efficiently produce a resin composition of polyvinyl chloride by removing lead in a resin molded article containing polyvinyl chloride as a main component and a lead-based stabilizer to recycle the resin molded article.

In some embodiments, provided is a method for producing a resin composition of polyvinyl chloride by removing lead in a resin molded article containing polyvinyl chloride as a main component and a lead-based stabilizer. The method includes: pulverizing the resin molded article to form a pulverized material; immersing the pulverized material in an acidic or alkaline liquid to dissolve lead contained in the lead-based stabilizer from the pulverized material into the liquid; and separating the pulverized material from the liquid in which the lead is dissolved.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a flowchart illustrating a procedure for producing a resin composition of polyvinyl chloride of the present embodiment;

FIGS. 2A to 2E are views schematically illustrating a state of each stage in a production process of the resin composition of polyvinyl chloride of the present embodiment;

FIG. 3 is a view illustrating an example of a pulverized material to be immersed in an acidic or alkaline liquid of the present embodiment; and

FIG. 4 is a view illustrating a schematic configuration of an extruder used for melting a pulverized material of the present embodiment.

### DETAILED DESCRIPTION

An embodiment of a method for producing a resin composition of the disclosure will be described with reference to the drawings.

In the method for producing a resin composition of the present embodiment, lead in a resin molded article containing polyvinyl chloride as a main component and a lead-based (Pb-based) stabilizer is removed to produce a resin composition of polyvinyl chloride. As a result, the resin molded article once produced is reused, and the resin molded article is recycled into a resin composition to newly produce a resin composition.

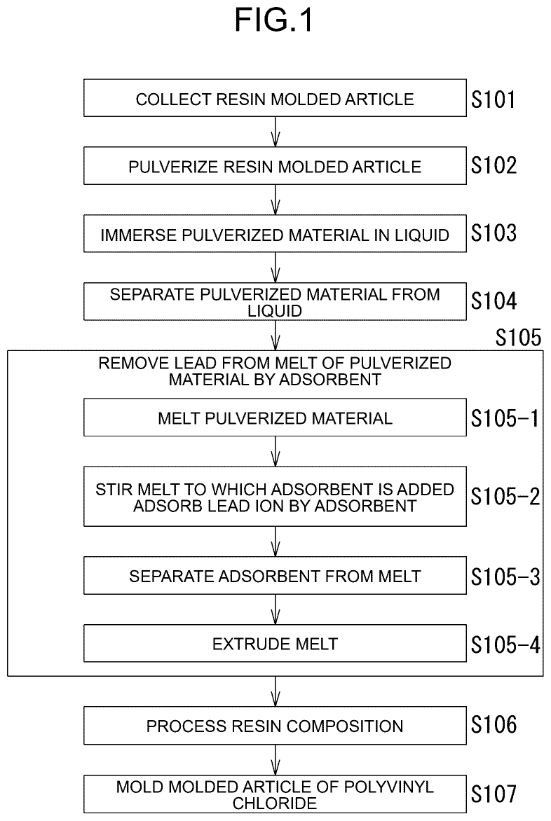

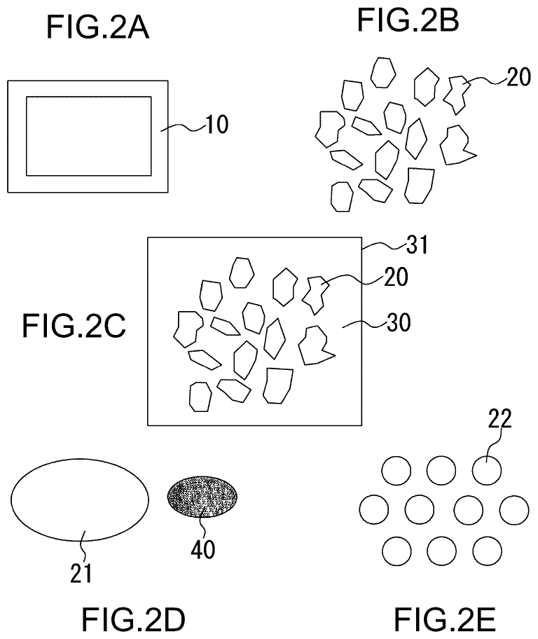

FIG. 1 is a flowchart illustrating a procedure (step) for producing a resin composition of polyvinyl chloride of the present embodiment. FIGS. 2A to 2E are views schematically illustrating a state of each stage in a process of producing the resin composition of polyvinyl chloride of the present embodiment.

As illustrated in the drawing, a resin molded article 10 (see FIG. 2A) that is no longer used is collected (S101 in FIG. 1). The resin molded article 10 is a molded article obtained by molding a synthetic resin. The synthetic resin is polyvinyl chloride (PVC), and the resin molded article 10 is a polyvinyl chloride molded article containing polyvinyl chloride as a main component and a lead-based stabilizer. The polyvinyl chloride is hard polyvinyl chloride to which a plasticizer is not added, or soft polyvinyl chloride to which a plasticizer is added. The plasticizer is an additive that imparts flexibility to polyvinyl chloride, and softens polyvinyl chloride.

The stabilizer is a heat stabilizer that suppresses pyrolysis of polyvinyl chloride, and suppresses decomposition of polyvinyl chloride by heat when the polyvinyl chloride is heated and molded. The lead-based stabilizer is a stabilizer containing lead as a component, and examples thereof include lead stearate, lead tribasic sulfate, lead dibasic phthalate, and lead dibasic stearate. The resin molded article 10 is formed of polyvinyl chloride, and contains various additives (for example, modifiers) in addition to the lead-based stabilizer. The resin molded article 10 is, for example, a resin profile, an injection molded article of synthetic resin, a resin sheet, or a resin hose.

Here, the resin molded article 10 is a resin profile, and FIG. 2A illustrates a cross section orthogonal to the longitudinal direction of the resin molded article 10. The resin profile is a profile (extruded profile) molded by extrusion molding of a synthetic resin, and the resin molded article 10 is a polyvinyl chloride profile formed of polyvinyl chloride. Specifically, the resin molded article 10 is a resin molded article (resin profile) used for a resin window which is a window unit. The resin window includes a frame (resin frame) made of a synthetic resin and a shoji screen including a stile (resin stile) made of a synthetic resin, and each of the resin frame and the resin stile is formed of the resin molded article 10.

As described above, the resin molded article 10 is a resin molded article (waste resin molded article) which is a discarded resin profile. A resin composition of polyvinyl chloride is produced by using the resin molded article 10 as a raw material, and removing lead contained in the lead-based stabilizer from the resin molded article 10. At this time, lead contained in the resin molded article 10 is removed and reduced by a lead removal treatment, and polyvinyl chloride is collected from the resin molded article 10. In the resin composition of polyvinyl chloride after production, the concentration of lead is lower than the concentration of lead in the original resin molded article 10. The resin composition of polyvinyl chloride is a composition containing polyvinyl chloride as a main component, and serves as a raw material for a molded article (recycled molded article) of polyvinyl chloride.

Before the lead removal treatment, the collected resin molded article 10 is pulverized by a pulverizer to form a pulverized material 20 (see FIG. 2B) of the resin molded article 10 (S102 in FIG. 1). The pulverizer is, for example, an impact crusher which is an impact type pulverizer. When the resin molded article 10 is long or large, for example, the resin molded article 10 is cut into a size that can be pulverized by the pulverizer, before pulverization by the pulverizer. In this way, the pulverized material 20 obtained by pulverizing the resin molded article 10 is produced. The pulverized material 20 is formed in, for example, a flake shape, a granular shape, or a powder shape.

After pulverizing the resin molded article 10 (see FIG. 2C), the pulverized material 20 of the resin molded article 10 is immersed in an acidic or alkaline liquid 30 to dissolve lead contained in the lead-based stabilizer of the resin molded article 10 from the pulverized material 20 into the liquid 30 (S103 in FIG. 1). The acidic or alkaline liquid 30 is a solution for dissolving lead in the pulverized material 20, and is stored in a container 31. The acidic liquid 30 is, for example, hydrochloric acid, sulfuric acid, or nitric acid, and is various acids not diluted with water or various acids diluted with water. The alkaline liquid 30 is, for example, an aqueous solution of sodium hydroxide.

The pulverized material 20 is placed in the liquid 30 in the container 31 to immerse the pulverized material 20 in the liquid 30. During immersion of the pulverized material 20 in the liquid 30, lead in the pulverized material 20 gradually dissolves in the liquid 30. Lead on the surface of the pulverized material 20 first dissolves in the liquid 30, and lead inside the pulverized material 20 gradually dissolves. By dissolving lead in the liquid 30, lead is removed from the pulverized material 20.

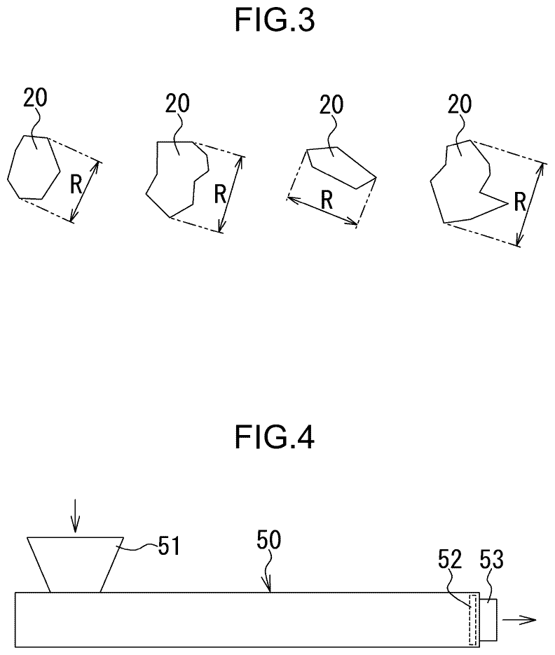

FIG. 3 is a view illustrating an example of the pulverized material 20 to be immersed in the acidic or alkaline liquid 30 of the present embodiment.

As illustrated in the drawing, the pulverized materials 20 having various shapes and maximum dimensions R are formed by pulverizing the resin molded article 10. The maximum dimension R of the pulverized material 20 is a dimension of a portion having the largest dimension in the outer shape of each of the pulverized materials 20. The maximum dimension R of the pulverized material 20 to be immersed in the liquid 30 is a dimension within a range of 200 μm to 10 mm. Therefore, at the time of pulverizing the resin molded article 10, the resin molded article 10 is pulverized so that the maximum dimension R of the pulverized material 20 is 200 μm to 10 mm. Alternatively, after pulverizing the resin molded article 10, the pulverized material 20 having a maximum dimension R smaller than 200 μm and the pulverized material 20 having a maximum dimension R larger than 10 mm are separated and removed using a separator or the like, to thereby select the pulverized material 20 having a maximum dimension R of 200 μm to 10 mm. The pulverized material 20 having a maximum dimension R of 200 μm to 10 mm is immersed in the liquid 30.

In the treatment of removing lead in the pulverized material 20 (resin molded article 10) by immersion of the pulverized material 20 in the liquid 30 (lead removal treatment of the pulverized material 20 by immersion), the pulverized material 20 is immersed in the liquid 30 while stirring the pulverized material 20 and the liquid 30. In addition, immersion of the pulverized material 20 in the liquid 30 is performed for a predetermined time in a state where the liquid 30 and the pulverized material 20 are heated to a predetermined temperature. For example, the pulverized material 20 is immersed in the liquid 30 for a predetermined time while stirring the pulverized material 20 and the liquid 30 in a state where the temperatures of the liquid 30 and the pulverized material 20 are maintained at predetermined temperatures by a thermostatic apparatus.

Next, the pulverized material 20 is taken out from the liquid 30 in which lead is dissolved, and the pulverized material 20 is separated from the liquid 30 (S104 in FIG. 1). Subsequently, the pulverized material 20 is washed with water by a water washing apparatus. The liquid 30 is washed away from the pulverized material 20 with water to clean the pulverized material 20. Thereafter, water is removed from the pulverized material 20 by a drying apparatus, to dry the pulverized material 20.

In the pulverized material 20 of the resin molded article 10 immersed in the liquid 30, the degree of dissolution of lead is different between the surface side and the center side. Therefore, after the lead removal treatment of the pulverized material 20 by immersion, a treatment of removing lead in a melt 21 (see FIG. 2D) of the pulverized material 20, which is obtained by melting the pulverized material 20, by an adsorbent 40 (lead removal treatment of the melt 21 by the adsorbent 40) is performed (S105 in FIG. 1). This removes lead remaining in the pulverized material 20 after immersion.

The melt 21 is a melt of polyvinyl chloride in which the pulverized material 20 is melted, and contains a lead-based stabilizer. When the temperature of the pulverized material 20 which is polyvinyl chloride is raised to melt the pulverized material 20, lead contained in the lead-based stabilizer becomes cations in the melt 21, and pyrolysis of polyvinyl chloride is suppressed by a lead ion which is a cation of lead. By adding the adsorbent 40 to the melt 21, the lead ion is adsorbed by the adsorbent 40, and lead is removed from the melt 21.

The adsorbent 40 is a solid cation adsorbent that adsorbs cations, and adsorbs the lead ion which is a cation in the melt 21 of the pulverized material 20. The adsorbent 40 is, for example, a double hydroxide such as zeolite, chitosan, a porous material, or a layered double hydroxide (LDH), and is formed in a powder shape or a granular shape. As the adsorbent 40, an inorganic adsorbent is used so as not to be decomposed even at the temperature of the melt 21.

The adsorbent 40 is added to the melt 21 by adding the adsorbent 40 to the pulverized material 20 before melting and then melting the pulverized material 20. Alternatively, after the pulverized material 20 is melted, and the adsorbent 40 is added to the melt 21. Here, the pulverized material 20 and the powdery adsorbent 40 (adsorbent powder) are charged into an extruder, and the pulverized material 20 is then melted by the extruder. Therefore, the adsorbent 40 is added to the pulverized material 20 before melting, and the pulverized material 20 is then melted.

FIG. 4 is a view illustrating a schematic configuration of an extruder 50 used for melting the pulverized material 20 of the present embodiment.

As illustrated in the drawing, the pulverized material 20 and the adsorbent 40 are charged into the extruder 50 from a charging port 51 (hopper) of the extruder 50 together with various additives. In the inside of the extruder 50, the temperatures of the pulverized material 20 and the adsorbent 40 are raised by heating by the extruder 50 to melt the pulverized material 20, thereby producing the melt 21 of the pulverized material 20 (S105-1 in FIG. 1). In this manner, the pulverized material 20 separated from the liquid 30 is melted to obtain the melt 21 of the pulverized material 20.

The pulverized material 20 and the adsorbent 40 are kneaded while being heated by the extruder 50, and the pulverized material 20 is melted by raising the temperature of the pulverized material 20. As a result, the solid adsorbent 40 that adsorbs a lead ion is added to the melt 21 of the pulverized material 20 in the extruder 50. In addition, a lead ion is generated in the melt 21 as the pulverized material 20 is melted. A screw (not illustrated) is provided inside the extruder 50. The extruder 50 stirs and kneads the melt 21 and the adsorbent 40 with a rotating screw. The melt 21 to which the adsorbent 40 is added is stirred by the extruder 50, the melt 21 and the adsorbent 40 are kneaded, and the lead ion in the melt 21 is adsorbed by the adsorbent 40 (S105-2 in FIG. 1). Lead is removed from the melt 21 by adsorption of the lead ion to the adsorbent 40.

Here, polyvinyl chloride as a main component of the resin molded article 10 is hard polyvinyl chloride, and the resin composition of polyvinyl chloride to be produced is a resin composition of hard polyvinyl chloride. Therefore, the temperature of the melt 21 of the pulverized material 20 is raised to a temperature suitable for melting the hard polyvinyl chloride. Specifically, the temperature of the pulverized material 20 is raised to a temperature within a range of 180 to 210° C. to melt the pulverized material 20. The melt 21 to which the adsorbent 40 is added is heated to a temperature within a range of 180 to 210° C., and the melt 21 and the adsorbent 40 are stirred at a temperature of 180 to 210° C. to remove lead (lead ion) contained in the melt 21 by the adsorbent 40.

Subsequently, the adsorbent 40 having the adsorbed lead ion is separated from the melt 21 (S105-3 in FIG. 1) to produce a resin composition of polyvinyl chloride from which lead has been removed. A filter 52 used for separating the adsorbent 40 is provided inside the extruder 50. The filter 52 is a sieve that filters the adsorbent 40 from the melt 21, and blocks the passage of the adsorbent 40 while allowing the passage of the melt 21. The extruder 50 allows the melt 21 to pass through the filter 52 to thereby separate the adsorbent 40 from the melt 21 by the filter 52.

The mesh (number) of the filter 52 is 20 to 100 mesh. The melt 21 is allowed to pass through the filter 52 in a range of 20 to 100 mesh to thereby separate the adsorbent 40 from the melt 21 by the filter 52 of 20 to 100 mesh. The mesh of the filter 52 is a mesh of a sieve specified in the ASTM standard (ASTM E11-04), and conforms to the ASTM standard. The opening of the filter 52 of 20 mesh is about 0.80 mm, and the opening of the filter 52 of 100 mesh is about 0.15 mm. Therefore, the opening of the filter 52 is about 0.15 to 0.80 mm.

By the extruder 50, melting of the pulverized material 20, stirring of the melt 21 to which the adsorbent 40 is added (adsorption of lead ion by the adsorbent 40), and separation of the adsorbent 40 from the melt 21 are continuously performed inside the extruder 50. Subsequently, the extruder 50 extrudes the melt 21 that has passed through the filter 52 from an extrusion port 53 (die), to perform extrusion molding of the melt 21 (S105-4 in FIG. 1). The extrudate of the melt 21 extruded from the extrusion port 53 is sequentially cut to form a pellet 22 (see FIG. 2E).

As described above, the resin composition of polyvinyl chloride which is the extruded melt 21 is processed to form the pellet 22 made of the resin composition of polyvinyl chloride (S106 in FIG. 1). The pellet 22 is a granular material containing polyvinyl chloride as a main component, and is formed in a granular shape. Thereafter, a molded article of polyvinyl chloride is molded using the pellet 22 of polyvinyl chloride (S107 in FIG. 1). The molded article of polyvinyl chloride is, for example, a resin profile molded by extrusion molding and used for windows units.

In the method for producing a resin composition of polyvinyl chloride of the present embodiment described above, it is possible to efficiently produce a resin composition of polyvinyl chloride by removing lead in the resin molded article 10 containing polyvinyl chloride as a main component and a lead-based stabilizer to recycle the resin molded article 10. In addition, lead in the resin molded article 10 can be easily removed.

Before performing the lead removal treatment of the melt 21 by the adsorbent 40, the lead removal treatment of the pulverized material 20 by immersion is performed. As a result, lead is removed from the pulverized material 20 before stirring of the adsorbent 40 and the melt 21 of the pulverized material 20, and thus the lead contents in the pulverized material 20 and the melt 21 can be reduced.

When the maximum dimension R of the pulverized material 20 is smaller than 200 μm, it is difficult to separate the pulverized material 20 from the liquid 30. After the pulverized material 20 is separated from the liquid 30, it may be difficult to perform water washing and drying of the pulverized material 20. When the maximum dimension R of the pulverized material 20 is larger than 10 mm, the surface area (specific surface area) per unit mass of the pulverized material 20 decreases, which may affect the efficiency of dissolving lead of the pulverized material 20 in the liquid 30. There is also a possibility that it becomes difficult to charge the pulverized material 20 into the extruder 50.

On the other hand, when the maximum dimension R of the pulverized material 20 is a dimension within a range of 200 μm to 10 mm (200 μm or more and 10 mm or less), the pulverized material 20 can be easily separated from the liquid 30. In addition, the specific surface area of the pulverized material 20 can be secured, so that the lead of the pulverized material 20 can be efficiently dissolved in the liquid 30. The pulverized material 20 can be smoothly washed with water, dried, and charged into the extruder 50. The maximum dimension R of the pulverized material 20 is more preferably a dimension within a range of 2 to 8 mm. As a result, the pulverized material 20 can be smoothly separated from the liquid 30, and thus the efficiency of dissolving the lead of the pulverized material 20 in the liquid 30 can also be secured.

In a case where the polyvinyl chloride is hard polyvinyl chloride, when the temperature at the time of stirring the melt 21 to which the adsorbent 40 is added (stirring temperature of the melt 21) is lower than 180° C., the viscosity of the melt 21 increases, which prevents flow of the melt 21 and may affect stirring of the melt 21. It is also difficult to perform extrusion molding of the melt 21 by the extruder 50. When the stirring temperature of the melt 21 is higher than 210° C., hard polyvinyl chloride of the melt 21 may be pyrolyzed.

On the other hand, when the stirring temperature of the melt 21 is in a range of 180 to 210° C. (180° C. or higher and 210° C. or lower), the viscosity of the melt 21 is set to a viscosity suitable for stirring while preventing pyrolysis of the hard polyvinyl chloride of the melt 21, thus making it possible to promote stirring by flow of the melt 21. The stirring temperature of the melt 21 is more preferably in a range of 190 to 200° C. This makes it possible to reliably prevent pyrolysis of hard polyvinyl chloride of the melt 21 while maintaining the viscosity of the melt 21 at a viscosity suitable for stirring.

The filter 52 allows the adsorbent 40 to be easily separated from the melt 21 of the pulverized material 20. However, when the filter 52 is a filter coarser than 20 mesh (filter with a smaller mesh number), there is a possibility that the adsorbent 40 cannot be completely separated from the melt 21. When the filter 52 is a filter finer than 100 mesh (a filter with a larger mesh number), the pressure applied to the melt 21 to pass through the filter 52 increases, which may affect the efficiency in separating the adsorbent 40 from the melt 21. An increase in the extrusion pressure of the melt 21 by the extruder 50 may also affect the productivity of the resin composition of polyvinyl chloride, and there is also a concern that the filter 52 may be damaged by the pressure of the melt 21.

On the other hand, when the mesh of the filter 52 is in a range of 20 to 100 mesh (20 mesh or more and 100 mesh or less), the adsorbent 40 can be stably separated from the melt 21 of the pulverized material 20, and an increase in the pressure applied to the melt 21 is suppressed, thus making it possible to secure the efficiency of separating the adsorbent 40 from the melt 21. In addition, an increase in the extrusion pressure of the melt 21 by the extruder 50 is suppressed, thus making it possible to secure the productivity of the resin composition of polyvinyl chloride, and to prevent the filter 52 from being damaged by the pressure of the melt 21. The mesh of the filter 52 is more preferably in a range of 40 to 80 mesh. This makes it possible to efficiently separate the adsorbent 40 from the melt 21 without applying a high pressure to the melt 21.

When the pulverized material 20 is melted, polyvinyl chloride containing no lead (lead-based stabilizer) may be added to the pulverized material 20 separated from the liquid 30, and the added polyvinyl chloride and the pulverized material 20 may be melted and mixed to produce a resin composition of polyvinyl chloride. The polyvinyl chloride to be added to the pulverized material 20 is a solid of polyvinyl chloride, and is formed in, for example, a powder shape or a granular shape. The polyvinyl chloride to be added to the pulverized material 20 is unused polyvinyl chloride containing no lead, or polyvinyl chloride obtained by pulverizing a molded article of polyvinyl chloride containing no lead, and may be either one or both of unused polyvinyl chloride and polyvinyl chloride obtained by pulverizing a molded article. The pulverized material 20, the adsorbent 40, and polyvinyl chloride containing no lead are charged into an extruder, and then the pulverized material 20 to which the polyvinyl chloride containing no lead is added is melted by the extruder 50 to obtain the melt 21 of the polyvinyl chloride and the pulverized material 20. By adding the polyvinyl chloride containing no lead, the concentration of lead contained in the resin composition of polyvinyl chloride can be reduced.

In the method for producing a resin composition of polyvinyl chloride described above, after performing a lead removal treatment of the pulverized material 20 by immersion (see FIG. 2C), a lead removal treatment of the melt 21 by the adsorbent 40 (see FIG. 2D) is performed. On the other hand, the resin composition of polyvinyl chloride may be produced by performing a lead removal treatment of the pulverized material 20 by immersion without performing a lead removal treatment of the melt 21 by the adsorbent 40. Even in this case, lead can be removed. In particular, when the concentration of lead in the resin composition of polyvinyl chloride can be reduced to the target concentration by the lead removal treatment of the pulverized material 20 by immersion, it is effective to perform the lead removal treatment of the pulverized material 20 by immersion without performing the lead removal treatment of the melt 21 by the adsorbent 40. However, by performing a lead removal treatment of the pulverized material 20 by immersion and then performing a lead removal treatment of the melt 21 by the adsorbent 40, the concentration of lead in the resin composition of polyvinyl chloride can be further reduced.

As described above, the present embodiment discloses the method for producing a resin composition described in the following (1) to (3).
(1) Provided is a method for producing a resin composition of polyvinyl chloride by removing lead in a resin molded article containing polyvinyl chloride as a main component and a lead-based stabilizer. The method includes: pulverizing the resin molded article to form a pulverized material; immersing the pulverized material in an acidic or alkaline liquid to dissolve lead contained in the lead-based stabilizer from the pulverized material into the liquid; and separating the pulverized material from the liquid in which the lead is dissolved.

In the method for producing a resin composition described in (1), it is possible to efficiently produce a resin composition of polyvinyl chloride by removing lead in a resin molded article containing polyvinyl chloride as a main component and a lead-based stabilizer to recycle the resin molded article.
(2) In the immersing in the method for producing a resin composition according to (1), a maximum dimension of the pulverized material to be immersed is within a range of 200 μm to 10 mm.

In the method for producing a resin composition described in (2), the pulverized material can be easily separated from the liquid, and lead of the pulverized material can be efficiently dissolved in the liquid.
(3) The method for producing a resin composition according to (1) or (2) further includes adding polyvinyl chloride containing no lead to the pulverized material separated from the liquid, and melting and mixing the polyvinyl chloride and the pulverized material.

In the method for producing a resin composition described in (3), the concentration of lead contained in the resin composition of polyvinyl chloride can be reduced by adding polyvinyl chloride containing no lead.

According to the disclosure, it is possible to efficiently produce a resin composition of polyvinyl chloride by removing lead in a resin molded article containing polyvinyl chloride as a main component and a lead-based stabilizer to recycle the resin molded article.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for producing a resin composition of polyvinyl chloride by removing lead in a resin molded article containing polyvinyl chloride as a main component and a lead-based stabilizer, the method comprising:
pulverizing the resin molded article to form a pulverized material;
immersing the pulverized material in an acidic or alkaline liquid to dissolve lead contained in the lead-based stabilizer from the pulverized material into the liquid; and
separating the pulverized material from the liquid in which the lead is dissolved.

2. The method for producing a resin composition according to claim 1, wherein
in the immersing, a maximum dimension of the pulverized material to be immersed is within a range of 200 μm to 10 mm.

3. The method for producing a resin composition according to claim 1, further comprising
adding polyvinyl chloride containing no lead to the pulverized material separated from the liquid, and melting and mixing the added polyvinyl chloride and the pulverized material.
